(19) United States
(12) Patent Application Publication
(10) Pub. No.: US 2025/0310868 A1
(43) Pub. Date: Oct. 2, 2025

(54) ENHANCED BROADCAST/MULTICAST TRANSMISSION AND RECEPTION ASSOCIATED WITH NON-TERRESTRIAL NETWORKS

(71) Applicant: InterDigital Patent Holdings, Inc., Wilmington, DE (US)

(72) Inventors: Dylan Watts, Montreal (CA); Moon-il Lee, Melville, NY (US); Oumer Teyeb, Montreal (CA); Umer Salim, Vallauris (FR); Brian Martin, Farnham (GB)

(73) Assignee: InterDigital Patent Holdings, Inc., Wilmington, DE (US)

(21) Appl. No.: 18/623,340

(22) Filed: Apr. 1, 2024

(51) Int. Cl. H04W 48/18; H04W 48/02; H04W 48/08

(52) U.S. Cl. CPC H04W 48/18; H04W 48/02; H04W 48/08

(57) ABSTRACT

Multicast and broadcast services (MBS) content data in non-terrestrial networks may be received as a function of whether device location fulfills access conditions and/or the validity of a service area. A device may receive radio network identifiers (RNTIs) with a validity period to decode MBS session data. The RNTIs provided may be a function of cell movement, device location, and/or MBS session area. A device may be configured to receive a list of MBS session IDs. The device may obtain the device's location information. The device may identify one or more valid MBS service areas. The device may transmit information for a network to verify satisfaction of one or more access conditions. The device may receive one or more radio network temporary identifiers (RNTIs) that may be associated with periods of validity. The device may use the RNTIs to decode the MBS data.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described herein related to enhanced broadcast/multicast transmission and reception in non-terrestrial networks. Multicast and broadcast services (MBS) content data may be received as a function of whether a wireless transmit/receive unit (WTRU) location has fulfilled access conditions and/or the validity of a service area. A WTRU may receive a series of radio network identifiers (RNTIs) to decode MBS session data, e.g., each with an associated validity period. The number of RNTIs provided to a WTRU may be a function of cell movement, WTRU location, and/or MBS session area.

A device (e.g., a WTRU) may (e.g., be configured to) do one or more of the following actions. The device may receive (e.g., via system information) a list of MBS session identifiers (IDs). The device may obtain the device's location information. The device may identify one or more valid MBS service areas. The device may transmit information for a network to verify satisfaction of one or more access conditions. The device may receive one or more radio network temporary identifiers (RNTIs) that may be associated with periods of validity. The device may use the RNTIs to decode the MBS data.

An example device may include a processor configured to perform one or more actions. For example, a device (e.g., a WTRU) may perform one or more of the following. A WTRU may receive (e.g., via system information) a list of session identifiers (IDs) (e.g., MBS session IDs). The WTRU may obtain (e.g., determine) location information for the WTRU (e.g., the location information may be information indicative of the location of the WTRU), and, the WTRU may identify (e.g., determine) one or more valid service areas (e.g., MBS service areas), for example, based on the location information. For example, the WTRU may determine that an service area associated with the WTRU is a valid MBS service area. The WTRU may transmit information to the network associated with satisfying access requirement(s) (e.g., the WTRU may, based on the determination that the service area associated with the WTRU is a valid service area, send an access request to a network node, such as a base station), where, for example, the access requirement(s) may be requirement(s) to access data (e.g., receive and/or decode data (e.g., MBS data). The WTRU may receive one or more RNTIs associated with decoding data (e.g., a type of data). For example, the WTRU may receive a message that indicates a first RNTI, an indication of a first period of validity associated with the first RNTI, a second RNTI, and a second period of validity associated with the second RNTI, etc. The WTRU may determine that one or more of the RNTIs are valid (e.g., valid to use for decoding the data) based on being within one or more of the periods of validity (e.g., the WTRU may determine that a first time is within the first period of validity, and, decode MBS data via use of the first RNTI based on the determination that the first time is within the first period of validity). The WTRU may determine that the first period of validity expired or is within a threshold of expiration. The WTRU may determine that a second time is within the second period of validity, where the second time is at or after expiration of the first period of validity. The WTRU may decode the data via use of the second RNTI based on the determination that the second time is within the second period of validity.

The one or more access requirements may comprise a requirement that the WTRU verify that the WTRU is in a location associated with allowing access to the data and/or a requirement that the network node verify a WTRU location. The one or more session IDs may comprise a first session ID and a second session ID. The first session ID may indicate one or more of: a first service area, a first service period associated with the first session ID, or a first access condition associated with the first session ID. The second session ID may indicate one or more of: a second service area, a second service period associated with the second session ID, or a second access condition associated with the second session ID. The first or second access condition may comprise: a condition that a time associated with access by the WTRU is a time when the WTRU is allowed to at least one of: access the data or decode the data; or a condition that the network node verify a WTRU location. The service area associated with the WTRU may be the first service area or the second service area. Determining that the service area associated with the WTRU is the valid service area may comprise: determining one or more of: that the time is within the first service period, that a location associated with the WTRU is within the first service area, or that the first access condition is satisfied; or, determining one or more of: that the time is within the second service period, that a location associated with the WTRU is within the second service area, or that the second access condition is satisfied

The access request may indicate one or more of: a session ID, wherein the session ID is one of the one or more session IDs, WTRU location information, or measurement information associated with measurements performed by the WTRU. The one or more session IDs may be one or more multicast broadcast service (MBS) IDs, the service area may be an MBS service area, the service period may be an MBS service period, and/or the data is MBS data. The one or more session IDs may be one or more service area IDs. Being associated with the same service may comprise being associated with a same session.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example comparing an MBS session area in a terrestrial network to an MBS session area in a non-terrestrial network.

FIG. 3 illustrates an example of cells within a session area changing over time, e.g., due to satellite movement.

FIG. 4 illustrates an example associated with decoding data.

### EXAMPLE NETWORKS FOR IMPLEMENTATION OF THE EMBODIMENTS

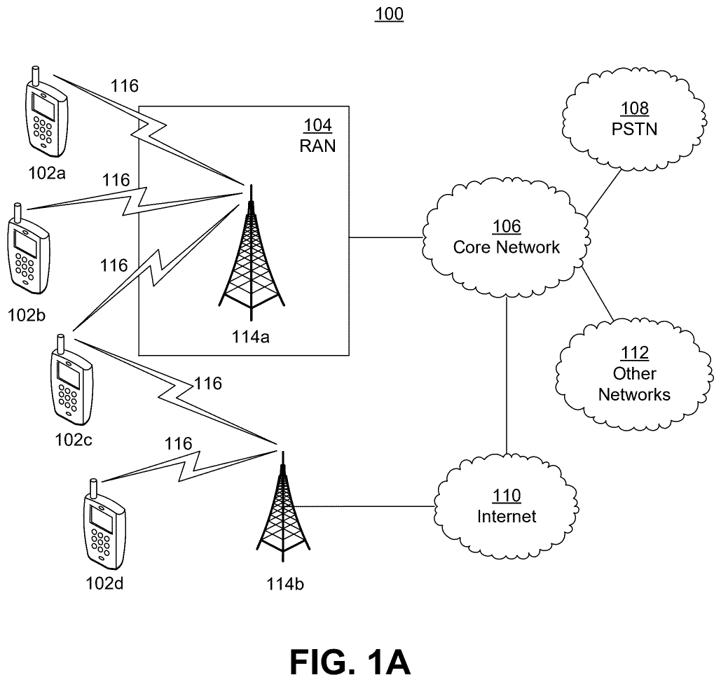

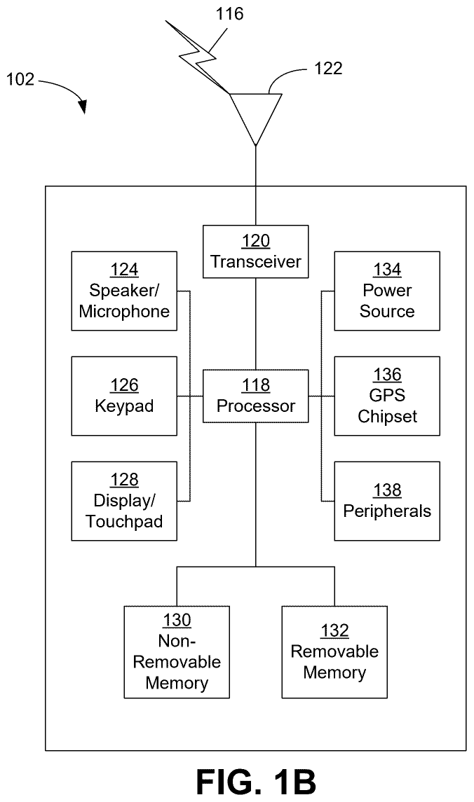

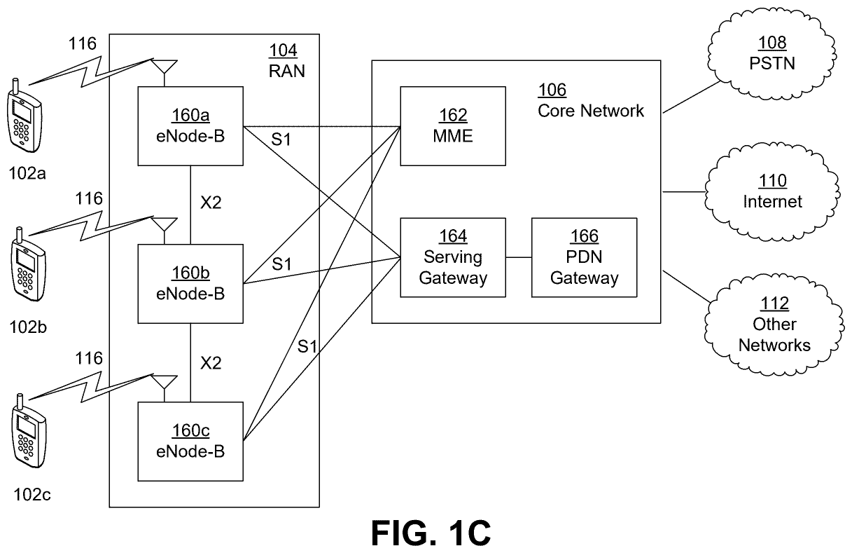

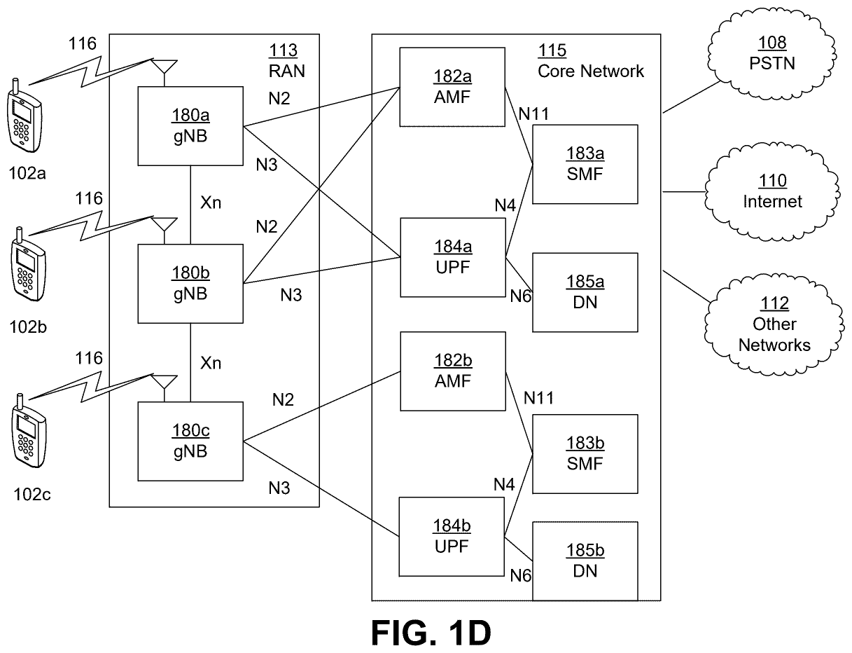

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are described herein related to enhanced broadcast/multicast transmission and reception in non-terrestrial networks. A WTRU may be configured to receive assistance information associated with a service area (e.g., a Multicast and Broadcast Service (MBS) service area). Assistance information associated with a service area may include, for example, one or more of the following: a description of one or more MBS service areas (e.g., per cell/beam, a reference point and radius, polygonal description, link to a terrestrial network (TN) area, country/city code, tracking area, which may be defined as a group of cells, etc.); a service period associated with the MBS service area (e.g., a start time, an end time, a duration, etc.); one or more conditions (e.g., requirements) to access the MBS content data (e.g., network (NW) verification of WTRU location); and/or an indication of if/when the access condition(s) (e.g., requirements) may be applied (e.g., currently, at some time in the future; at a location).

A WTRU may be configured to obtain location information and/or to identify one or more valid service areas. A service area may be considered valid, for example, based on satisfaction of one or more of the following conditions: the WTRU location is within the defined service area; the current time (e.g., coordinated universal time (UTC) time) is within the service period; and/or the WTRU satisfies the condition(s) (e.g., requirement(s)) to access the data (e.g., the WTRU location information has been verified).

A WTRU may be configured to transmit a service access request, which may include information (e.g., necessary information) to fulfill the access condition(s)/requirement(s) (e.g., prior to the requirement(s) being applied). The information may include, for example, one or more of the following: an MBS session identifier (ID) or service area ID; WTRU location information (e.g., global navigation satellite system (GNSS) information); measurements and/or information (e.g., required) for network to verify WTRU location (e.g., reference signal received power (RSRP) of current and neighboring cells, timing advance (TA) information, etc.).

A WTRU may be configured to receive one or more radio network identifiers (RNTIs) to decode the data (e.g., upon satisfaction of the access condition(s)/requirement(s)). The RNTI may be associated with a period of validity (e.g., activation time and validity duration).

A WTRU may be configured to apply the RNTI (e.g., associated with the current time period) to decode the data. The WTRU may select a different (e.g., valid) RNTI to continue decoding the data, for example, if the period of validity associated with the current RNTI expires. The WTRU may re-initiate the service area access procedure, for example, if there are no valid RNTIs remaining.

A WTRU may be configured to perform one or more of the following, for example, if the service period is about to expire (e.g., based on one or more expiry conditions such as the end time of the service period): the WTRU may identify one or more valid neighboring cells that may (e.g., also) be transmitting the data associated with the service area; the WTRU may (e.g., at (or prior to) expiry of the service period for the current serving/camped cell) perform mobility/cell reselection to a valid neighboring cell that (e.g., also) broadcasts the data associated with the service area; the WTRU may (e.g., if more than one suitable neighboring cell is available) rank neighboring cells based on, for example, one or more of the following criteria: cell measurements (e.g., RSRP, remaining service period associated with the service area, remaining time of cell service, etc.); and/or the WTRU may send an indication to the network, for example, if there are no neighboring cell(s) (e.g., suitable neighboring cell(s) available.

A Non-Terrestrial Network (NTN) may include an aerial and/or space-borne platform configured (e.g., via a gateway (GW)) to transport signals from a land-based based gNB to a WTRU and/or vice-versa. Aerial or space-borne platforms may be classified in terms of orbit. A non-geosynchronous orbit (NGSO) satellite may have a low-earth orbit (LEO) with an altitude range of 300-1500 km. A medium-earth orbit (MEO) satellite may have an altitude range of 7000-25000 km. NGSO satellites may move continuously overhead relative to earth. Geosynchronous orbit (GSO) satellites may remain fixed overhead, for example, by maintaining an altitude at 35,786 km.

Satellite platforms may be (e.g., further) classified as having a “transparent” or “regenerative” payload. Transparent satellite payloads may implement frequency conversion and/or RF amplification in uplink and/or downlink. Transparent satellite payloads may be associated with multiple transparent satellites that may be connected to a (e.g., one) land-based gNB. Regenerative satellite payloads may implement a full gNB or a gNB distributed unit (DU) onboard the satellite. Regenerative payloads may perform digital processing on the signal, which may include one or more of the following: demodulation, decoding, re-encoding, re-modulation, and/or filtering.

An NTN satellite may support multiple cells. A (e.g., each) cell may include one or more satellite beams. Satellite beams may cover a footprint on Earth (e.g., like a terrestrial cell). Satellite beams may range in diameter, such as from 100-1000 km in NGSO deployments, 200-3500 km diameter in GSO deployments, etc. Beam footprints in GSO deployments may remain fixed relative to Earth. The area covered by a beam/cell in NGSO deployments may change over time, e.g., due to satellite movement. Beam movement may be classified as “earth moving,” where a beam (e.g., NGSO beam) moves continuously across the earth, or “earth fixed,” where a beam may be steered to remain covering a fixed location, for example, until another (e.g., new) cell overtakes the coverage area, e.g., in a discrete and/or coordinated change.

Non-terrestrial networks may pose challenges, including one or more of the following: 1) continuous movement of NGSO satellites overhead may result in frequent and/or continuous cell change; 2) cell sizes up to 3500 km in diameter; and/or 3) round trip times (RTT) several orders of magnitude larger than terrestrial networks (e.g., up to 541.46 ms).

Multicast and Broadcast Service (MBS) may be a point-to-multipoint service in which data may be transmitted from a single source entity to multiple recipients, e.g., via broadcast and/or multicast transmission. A broadcast communication service may provide the same service and content data simultaneously to (e.g., all) WTRUs in an MBS service area, which may be identified by a cell list and/or a tracking area list. A multicast communication service may provide the same service and content data simultaneously to a (e.g., dedicated) set of WTRUs (e.g., not all WTRU in an MBS service area may be authorized to receive the data). A gNB may deliver MBS multicast data packets using one or more of the following methods: point to point (PTP) transmission and/or point to multipoint (PTM) transmission.

In an example of PTP transmission, a gNB may (e.g., individually) deliver separate copies of MBS data packets to each WTRU independent of delivery to other WTRUs. For example, a gNB may perform a PTP transmission using a WTRU-specific physical downlink control channel (PDCCH) transmission with a cyclic redundancy check (CRC) scrambled by a WTRU-specific radio network identifier (RNTI) (e.g., cell RNTI (C-RNTI)) to schedule a WTRU-specific physical downlink shared channel (PDSCH) transmission, which may be scrambled with the same WTRU-specific RNTI.

In an example of PTM transmission, a gNB may deliver a (e.g., single) copy of MBS data packets to a set of WTRUs. For example, a gNB may perform a PTM transmission using a group-common PDCCH with a CRC scrambled by a group-common RNTI (G-RNTI) to schedule a group-common PDSCH, which may be scrambled with the same G-RNTI.

Broadcast/multicast data may be restricted to sub-cell granularity. MBS service areas may be defined, for example, via a cell ID list and/or a tracking area ID (TAI) list. Terrestrial cells may be fixed. Terrestrial cell coverage area may be relatively limited. Geographical area or civic address information may be (e.g., readily) translated into a list of cells, for example, by a network exposure function (NEF) and/or MBS function (MBSF).

NTN cell sizes may range from 100 km to 3500 km diameter, which may cover multiple countries. Defining a geographic location in terms of cells may be unsuitable, for example, because it may be likely that at least a portion of a cell may cover a region where data from an MBS session cannot be transmitted/received (e.g., due to regulatory requirements, due to licensing and/or intellectual property (IP) agreements, etc.).

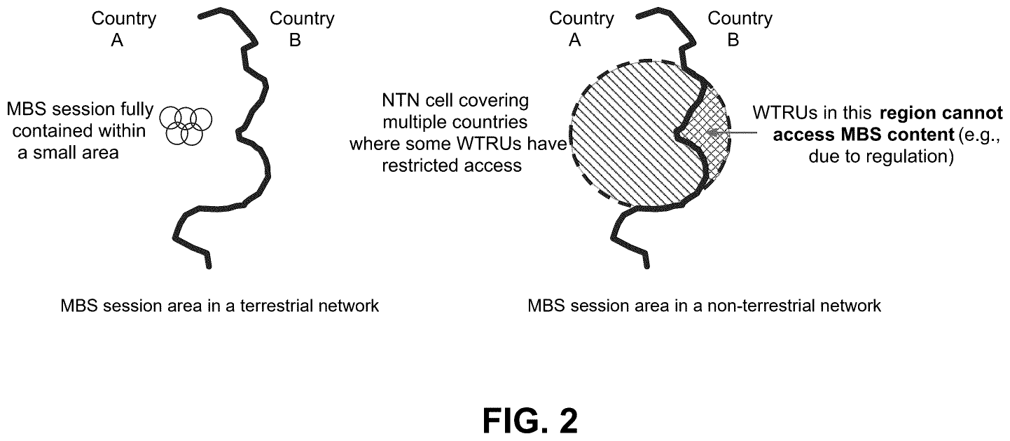

FIG. 2 illustrates an example comparing an MBS session area in a terrestrial network (left) to an MBS session area in a non-terrestrial networks (right).

Given that NGSO satellites move continuously relative to Earth, a cell (e.g., satellite) within the boundaries of a country at time T1 may cross into a region where the MBS session may not be applicable at time T2. This may mean that the cells that make up an MBS session area may change over time due to satellite movement, which may require methods to dynamically update the MBS session area.

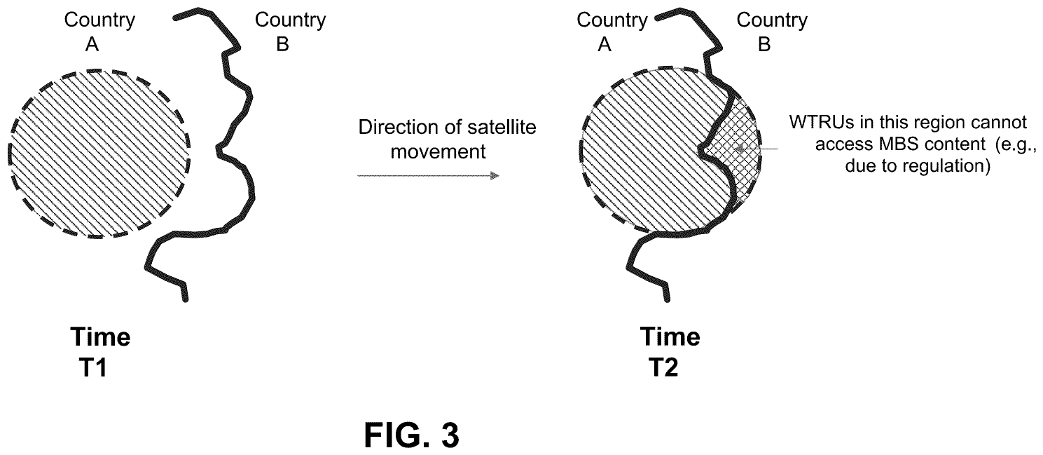

FIG. 3 illustrates an example of cell(s) (e.g., satellite(s)) within a session area changing over time, e.g., due to satellite movement. In some examples, in FIGS. 2 and 3, Country A and Country B may be replaced with service area A and service area B.

An MBS service area may be defined by a cell ID list and/or a tracking area ID list, which may include geographically fixed cells. There may not be a “sub-cell” MBS session area or a “validity duration” for cells making up an MBS session area.

Feature(s) associated with one or more of the following may be provided. A broadcast/multicast session area may be indicated at a finer granularity than a cell. Cells and/or portions of cells that make up an MBS session area may be dynamically updated, e.g., due to satellite movement. A WTRU that is in a cell (e.g., satellite footprint or coverage area), but outside an MBS session area, may be prevented from receiving data.

MBS content data may be received as a function of whether a WTRU location has fulfilled access conditions (e.g., requirements) and/or the validity of a service area. A WTRU may receive a series of RNTIs to decode MBS session data, e.g., each with an associated validity period. The number of RNTIs provided to a WTRU may be a function of cell movement, WTRU location, and/or MBS session area.

One or more of the following may be performed. A WTRU may receive (e.g., via system information) a list of session identifiers (IDs) (e.g., MBS session IDs). The WTRU may obtain (e.g., determine) location information for the WTRU (e.g., the location information may be information indicative of the location of the WTRU), and, the WTRU may identify (e.g., determine) one or more valid service areas (e.g., MBS service areas), for example, based on the location information. For example, the WTRU may determine that an service area associated with the WTRU is a valid MBS service area. The WTRU may transmit information to the network associated with satisfying access requirement(s) (e.g., the WTRU may, based on the determination that the service area associated with the WTRU is a valid service area, send an access request to a network node, such as a base station), where, for example, the access requirement(s) may be requirement(s) to access data (e.g., receive and/or decode data (e.g., MBS data). The WTRU may receive one or more RNTIs associated with decoding data (e.g., a type of data, such as MBS-type data). A RNTI may be associated with a service area. In examples, the WTRU may receive a message that indicates a first RNTI, an indication of a first period of validity associated with the first RNTI, a second RNTI, and a second period of validity associated with the second RNTI, etc. The WTRU may determine that one or more of the RNTIs are valid (e.g., valid to use for decoding the data) based on being within one or more of the periods of validity (e.g., the WTRU may determine that a first time is within the first period of validity, and, decode MBS data via use of the first RNTI based on the determination that the first time is within the first period of validity). The WTRU may determine that the first period of validity expired or is within a threshold of expiration. The WTRU may determine that a second time is within the second period of validity, where the second time is at or after expiration of the first period of validity. The WTRU may decode the data via use of the second RNTI based on the determination that the second time is within the second period of validity. MBS session ID, MBS service area, MBS data, and the like, may be used herein as examples of session ID, service area, data, and the like without loss of generality.

The one or more access requirements may comprise a requirement that the WTRU verify that the WTRU is in a location associated with allowing access to the data. The one or more session IDs may comprise a first session ID and a second session ID. The first session ID may indicate one or more of: a first service area, a first service period associated with the first session ID, or a first access condition associated with the first session ID. The second session ID may indicate one or more of: a second service area, a second service period associated with the second session ID, or a second access condition associated with the second session ID. The first or second access condition may comprise a condition that a time associated with access by the WTRU is a time when the WTRU is allowed to at least one of: access the data or decode the data. The service area associated with the WTRU may be the first service area or the second service area. Determining that the service area associated with the WTRU is the valid service area may comprise: determining one or more of: that the time is within the first service period, that a location associated with the WTRU is within the first service area, or that the first access condition is satisfied; or, determining one or more of: that the time is within the second service period, that a location associated with the WTRU is within the second service area, or that the second access condition is satisfied

The access request may indicate one or more of: a session ID, wherein the session ID is one of the one or more session IDs, WTRU location information, or measurement information associated with measurements performed by the WTRU. The one or more session IDs may be one or more multicast broadcast service (MBS) IDs, the service area may be an MBS service area, the service period may be an MBS service period, and/or the data is MBS data. The data may be MBS-type data. The one or more session IDs may be one or more service area IDs. Being associated with the same service may comprise being associated with a same session.

A network entity (e.g., a network node, such as a base station) may receive the access request from the WTRU. The network entity may verify information in the access request. For example, the network entity may determine that the WTRU is allowed to access the data. The network entity determining that the WTRU is allowed to access the data may comprise the network entity determining that measurements indicated in the access request indicate that the location of the WTRU is a location where the WTRU is allowed to access the data (e.g., the location is not a location that would indicate the WTRU is prohibited from accessing the data). The network entity may send a plurality of RNTIs to the WTRU (e.g., comprising the first and second RNTIs). For example, the network entity may send the plurality of RNTIs based on the determination by the network entity that the WTRU is allowed to access the data. In one possible example, by sending multiple RNTIs to the WTRU, the network entity may control how long the WTRU can access data based on how close the network entity determines that the WTRU will be to a border (e.g., a border where access is no longer permissiblel).

A WTRU may receive (e.g., via system information) a list of MBS session IDs (e.g., session identifiers). An MBS session ID (e.g., session ID) may include one or more of the following: an indication and/or description of one or more MBS service area(s) (e.g., per cell/beam, a reference point and radius, polygonal description, link to TN area, country/city code, tracking area defined as a group of cells, etc.); a service period associated with the MBS service area (e.g., a start time, an end time, a duration, etc.), for example a respective service period associated with a respective service area; condition(s) (e.g., requirements) to access the MBS content data (e.g., content data, data, etc.) (e.g., where the condition(s) may include an indication of whether NW verification of WTRU location is required); and/or an indication if and/or when access conditions (e.g., requirements) may be applied (e.g., currently, at some time in the future, etc.).

The WTRU may obtain/determine the WTRU's location information. The WTRU may identify one or more valid MBS service areas (e.g., based on the WTRU's location information). An MBS service area may be considered valid, for example, based on satisfaction of one or more of the following conditions: the WTRU location is within a defined MBS service area; a time, such as a current time, e.g., UTC time, is within the MBS service period; or the WTRU satisfies the condition(s) (e.g., requirement(s)) to access the data (e.g., the WTRU location information has been verified, for example verified by the WTRU).

The WTRU may (e.g., if there are condition(s)/requirement(s) to access the data, such as at a current time or at a future time) transmit information (e.g., an access request) to fulfill a condition(s)/requirement(s). The WTRU may transmit the information to fulfill the condition(s)/requirement(s) prior to the condition(s)/requirement(s) being applied (e.g., using FIG. 3 as an example, the WTRU may transmit the information at Time T1, for example prior to Time T2, at which time access requirements and/or restrictions may be applied, e.g., by the network). The transmitted information may include, for example, one or more of the following: an MBS session ID; the WTRU's location information (e.g., GNSS information); or measurements and/or information that may be used by a network to verify the WTRU's location (e.g., RSRP of current and neighboring cells, TA information, etc.).

The WTRU may receive one or more RNTIs. The one or more RNTIs may be used to decode the MBS data (e.g., upon satisfaction of the access requirements). An RNTI (e.g., each RNTI) may be associated with a period of validity (e.g., activation time and/or validity duration). For example, a received first RNTI may be associated with a first period of validity and a received second RNTI may be associated with a second period of validity.

The WTRU may apply and/or use a RNTI of the one or more RNTIs, for example, a RNTI associated with the current time period (e.g., a RNTI for which a first usage time satisfies a corresponding period of validity), to decode the MBS data. The WTRU may (e.g., if the period of validity associated with the current RNTI expires) select a different RNTI, for example, a RNTI for which a second usage time satisfies a corresponding period of validity, (e.g., a valid RNTI) to decode (e.g., continue decoding) the MBS data (e.g., MBS-type data).

The WTRU may perform (e.g., repeat) one or more of the operations/actions described herein to obtain additional RNTI(s) (e.g., to continue decoding MBS-type data), for example, if there are no remaining valid RNTIs. For example, the WTRU may send one or more of the following: an MBS session ID (e.g., another MBS session ID); the WTRU's location information (e.g., location information associated with when the WTRU is performing the repeated operation(s)/action(s)); or measurements and/or information that may be used by a network to verify WTRU location (e.g., associated with when the WTRU is performing the repeated operation(s)/action(s).

In some examples, a WTRU performing one or more of the operations/actions may continue decoding MBS session data from a current cell and/or a network may continue to transmit MBS data, for example, even though the cell may enter an area that is restricted to MBS service (e.g., due to regulatory requirements).

“MBS service,” “MBS session,” and “service” may be used equivalently herein, for example, to describe a data/content sent within a service/session area.

“MBS data”, “MBS content,” and “service data” may be used equivalently herein, for example, to describe transmission(s) and/or reception(s) provided as part of an MBS service.

“Session area” and “service area” may be used equivalently herein, for example, to refer to an area (e.g., area associated with an MBS service or geographic area) where a broadcast or multicast session or service may be provided. “Session ID” may be used equivalently herein, for example, to refer to “Service ID” or “service area ID.”

“Sub-cell service area” refers to an area (e.g., geographic area) that may cover a portion of one or more cells.

“Service requirement” refers to a requirement applied for a WTRU to access service data (e.g., the network may require or validate one or more pieces of information prior to the WTRU being able to receive service data).

“Access request,” “access report,” and “access requirement report” may be used equivalently to refer to a request by a WTRU that may include information to verify that a WTRU can access a restricted service area (e.g., a service area with requirements).

Although examples described herein may refer to an MBS traffic use case (e.g., data, content, etc.), examples described herein may be (e.g., equally) applied to any type of transmission, reception, or channel (e.g., PDCCH, PDSCH, etc.).

Although examples described herein refer to an MBS service or session area, examples described herein may be (e.g., equally) applied to any type of transmission or reception provided within a described area.

Although examples described herein may refer to a specific non-terrestrial network deployment type (e.g., NGSO, GSO, etc.), examples described herein may be (e.g., equally) applied to other (e.g., all) non-terrestrial deployments.

Although examples described herein may refer to a non-terrestrial transmission scenario, examples described herein may be (e.g., equally) applied to a cell or cells originating from any network type (e.g., terrestrial cells).

Although examples described herein may refer to a cell moving relative to Earth and/or may use the context of a cell originating from an NGSO satellite, examples described herein involving an Earth moving cell may (e.g., equally) apply to other moving cells, such as a mobile integrated access/backhaul (IAB) node.

Although examples described herein may refer to multicast data transmission, examples described herein may (e.g., equally) apply to broadcast data communication.

Examples described herein are applicable to a WTRU in any RRC state (e.g., CONNECTED, IDLE, INACTIVE). For example, a WTRU may receive a (e.g., required) configuration to access multicast/broadcast data while in connected mode (e.g., via dedicated RRC message, system information block (SIB) signaling, etc.) or may receive a broadcast signal while in IDLE/INACTIVE mode. A WTRU may receive configuration information while in a CONNECTED state, but use the configuration information after transitioning to an IDLE/INACTIVE state. A WTRU may (e.g., alternatively) be provided with a (e.g., required) configuration upon transitioning to an IDLE/INACTIVE state (e.g., in an RRC Release message). A WTRU may have indicated interest in reception of a multicast/broadcast session (e.g., while in CONNECTED state, via a connection setup/resume request while in IDLE/INACTIVE state, etc.). A network may send an indication (e.g., RRC reconfiguration message, paging message to bring the WTRU to CONNECTED state, broadcast message while the WTRU is in IDLE/INACTIVE) to the WTRU when the multicast/broadcast session starts/resumes, and/or a configuration (e.g., required) to access the service.

Some examples described herein may be considered to be conditional reconfigurations that the WTRU applies based on one or more (e.g., certain) conditions (e.g., time related condition(s). The impacted configuration may affect (e.g., only) the configuration elements/components that may be related to multicast/broadcast data reception (e.g., as compared with legacy conditional reconfigurations, where the reconfigurations may be triggered due to mobility and/or may affect one or more (all) elements/components of the WTRU configuration). Some examples may be implemented similar to conditional handover (CHO) configurations (e.g., an enhanced Cond Event T1, or a new Cond Event Tx, which may be associated with a delta RRC reconfiguration that modifies the G-RNTI value associated with the MBS configuration).

A sub-cell session area may be defined. A “sub-cell session area” may be defined as an area (e.g., within a cell) that belongs to the service area. In some examples (e.g., in non-terrestrial networks with large cell sizes), a service area may cover a portion of one or more cells. A WTRU that may be connected to a cell, but outside of a service area, may be prevented from receiving service data, for example, based on a sub-cell session area. A sub-cell coverage area may be described in one or more ways. In some examples, a WTRU may receive a description of a service area, e.g., other than a cell, cell list, or tracking area identity (TAI) list. For example, a service area may be described, for example, via one or more of the following: a reference point and radius; information to describe an ellipse or set of ellipses (e.g., a reference point, semi-major, and semi-minor axis); a set of reference points and radii; a set of reference points that form a shape (e.g., describing a polygonal area); an association with a terrestrial coverage area; and/or a satellite or list of satellites (e.g., identified by an NTN-config).

A service area description may include a combination of one or more of the different types of descriptions. A network may (e.g., further) describe whether an area is a union or intersection of one or more areas. A service area may be defined as fixed on Earth (e.g., describing a geographic area). A service area may be described as an area within a cell (e.g., the service area is defined relative to a point/area within the cell).

A WTRU may determine that a service area is described via an alternative method (e.g., not via a cell or tracking area identifier (TAI) list), for example, by an explicit indication (e.g., in a flag), or implicitly (e.g., via the presence of one or more types of information that may be used to describe the service area).

A session area (e.g., full session area) may be described. Information related to a service area description may be associated with a (e.g., particular) cell, satellite, service area, and/or MBS session/service ID. The information may be provided in system information and/or via other signaling, such as RRC, downlink control information (DCI), a medium access control (MAC) control element (CE), or non-access stratum (NAS) signaling.

In some examples, a service area may be entirely (e.g., fully contained) within a given cell. A service area entirely within a cell may be indicated explicitly (e.g., via a flag bit, or by providing a list including only one cell), or a WTRU may determine that a service area is entirely within a cell implicitly (e.g., by detecting that the service area is within a satellite footprint).

In some examples, a service area may span (e.g., consist of) more than one cell. The network may indicate which cell(s) within the cell list: 1) fully overlap with a service area; or 2) partially overlap with the service area. The network may (e.g., also) provide a description of an area (e.g., via one or more types of description described herein), for example, for cell(s) that partially overlap with the service area.

Service area validity may be configured. In some examples, one or more cell(s) (e.g., originating from an NGSO satellite) belonging to a service area may be moving relative to Earth. The cell coverage area (e.g., some or all of the cell coverage area) may move outside of the service area. A “validity duration” may be defined where a cell (e.g., all or a portion) may be considered as belonging to a service area. A WTRU may determine which session areas are applicable and/or valid.

Service area validity criteria may be configured. In some examples, a service area may span (e.g., consist of) one or more cell(s) moving relative to Earth. In some examples, the cell coverage area (e.g., some or all) may move outside of the service area, causing the cell to no longer transmit service data and/or to apply (e.g., additional) service conditions (e.g., requirements) to access the data (e.g., as described herein).

In some examples, a WTRU may assume or determine that a cell belonging to a service area may be associated with one or more validity criteria. A cell satisfying the one or more validity criteria may (e.g., be permitted to) transmit data associated with the service area. In some examples, a WTRU may determine or consider validity criteria to be satisfied if the current serving cell belongs to the list of cells making up the service area. In some examples, a WTRU may assume or determine that one or more validity criteria is satisfied based on an (e.g., explicit) indication that a service area is supported by a cell (e.g., via broadcast information, RRC configuration, MAC CE, DCI, or NAS signaling). In some examples, a WTRU may assume or determine that that a service area is valid implicitly, for example, based on the presence of information related to the service area (e.g., whether the service area information is indicated within a cell, or an expiry condition associated with the service area is not satisfied, etc.).

In some examples, a service area (e.g., a cell, cell list, TAI list, geographic area or sub-cell area) may be associated with a validity period. A WTRU may assume a cell transmits service data corresponding to the service area, for example, during a service area validity period. Service data may no longer be transmitted by a cell, for example, upon reaching the end of a validity period (e.g., due to a cell or portion of cell coverage crossing a border into a restricted country).

The start of the validity period may be associated with an activation condition. For example, a service area may be associated with one or more of the following activation conditions: activate based on starting cell coverage (e.g., upon t-ServiceStart) and/or based on reaching a specific time (e.g., 10:20:34 UTC).

Service area expiry conditions may be configured. A WTRU may consider or determine a service area as “expired” or “not valid” within the cell, for example, if a (e.g., particular) cell is no longer transmitting service data associated with a service area. Whether a service area is considered expired may be based on, for example, satisfaction of an expiry condition. A WTRU may consider a cell as not valid for reception/transmission of service data, for example, if one or more of the associated expiry conditions is satisfied.

A service area may have (e.g., be associated with) one or more of the following expiry conditions: reaching the end of cell coverage (e.g., upon t-Service); reaching a specific time (e.g., 10:23:34 UTC); at the end of a time duration or offset; satisfaction of a condition; notification that the service area information has been updated (e.g., via a flag in system information or a dedicated network message); (re) configuration; and/or release from the network.

A service area may be associated with an expiration condition, such as at the end of a time duration or offset. For example, a WTRU may consider a service area as valid from the beginning of a time duration. At the end of the time duration (e.g., or at a fixed offset from the time), the WTRU may consider the service area as expired. A duration and/or the time offset may be provided to the WTRU, e.g., along with the service area and/or MBS service ID. A duration and/or the time offset may be maintained, for example, via a WTRU timer.

A service area may be associated with an expiration condition, such as satisfaction of a condition. For example, a WTRU may set a WTRU location (e.g., at the time of the service area validity period activation) as the reference location. The WTRU can consider or determine the validity criteria as expired, for example, if the WTRU has moved more than a configured distance threshold. The distance threshold may be provided to the WTRU to perform the evaluation.

A service area may be associated with an expiration condition, such as a (re) configuration. For example, the network may disable or deactivate a service area (e.g., or, alternatively, the MBS service itself). The WTRU may consider the service area as expired, for example, based on (e.g., upon) reception of the reconfiguration.

A service area may be associated with an expiration condition, such as release from the network. For example, the WTRU may consider a service area as expired based on (e.g., upon) being released to RRC INACTIVE state (e.g., upon reception of an RRC_Release with suspend indication) or based on (e.g., upon) being released to RRC IDLE state (e.g., upon reception of an RRC_Release message).

Information related to service area validity, validity period, validity period activation, and/or validity period expiry may be associated with a (e.g., particular) cell, service area, and/or MBS session/service ID. The information may be provided, for example, in system information and/or via other signaling, such as RRC, DCI, MAC CE, or NAS signaling.

A service area validity determination may be based on a WTRU calculation. In some examples, a WTRU may estimate the validity period of a service area. The estimation may be based on, for example, service area information, cell footprint, and/or one or more other characteristics of the satellite such as one or more of the following: the time when a satellite may or will end coverage (e.g., t-Service); assistance information to determine the trajectory of the satellite/cell, such as the satellite ephemeris data (e.g., the satellite location, direction, speed, and/or orbital information); a cell and/or beam reference point; assistance information to determine the trajectory of a satellite reference point (e.g., if the satellite deployment uses earth-moving beams); satellite footprint information (e.g., satellite footprint diameter, cell footprint diameter, and/or beam footprint diameter); and/or a beam configuration for a cell and/or satellite (e.g., the total number of beams on a satellite, the number of beams within a cell, the pattern of beams within a cell, and/or the polarization characteristics of a beam).

In some examples, a WTRU may receive information related to a service area, satellite trajectory information, and/or cell footprint information (e.g., a cell reference point, and cell radius). A WTRU may determine the distance of a cell reference point from the service area. The WTRU may, e.g., via the cell radius, determine whether the cell footprint overlaps with the service area. The WTRU may calculate how cell coverage may move over time, for example, using the satellite (e.g., and/or reference point) trajectory information. The WTRU may (e.g., then) determine if the cell coverage may or will overlap with a service area and/or the (e.g., potential or actual) time period of overlap. The WTRU may assume or determine that the cell may broadcast service data associated with the service area during the time of overlap.

A WTRU may evaluate which service area(s) may be suitable/valid. A cell may support transmission of service data related to one or more service areas. A WTRU may (e.g., be able to) receive service data from one or more of the service(s)/service area(s), for example, based on the WTRU circumstances (e.g., WTRU location information). A WTRU may determine which service area(s) the WTRU can receive information from and at what time(s) (e.g., based on one or more of the following).

A WTRU may determine a valid service area based on provided information. A WTRU may receive assistance information associated with a service/service area to support a WTRU determination whether a given service area applies. In an example, a service area (e.g., each service area) may provide assistance information including, for example, one or more of the following: a description of one or more service areas (e.g., per cell/beam, a reference point and radius, polygonal description, link to TN area, country/city code, tracking area defined as a group of cells, etc.); a service period associated with the service area (e.g., indicated by start time, end time, duration, etc.); conditions (e.g., requirements) to access the service data (e.g., as described herein); and/or when access requirements may be applied (e.g., currently or at a time in the future).

Service area assistance information may be associated with a (e.g., particular) cell, service area, and/or MBS session/service ID. The information may be provided in system information and/or via other signaling, such as RRC, DCI, MAC CE, or NAS signaling.

A WTRU may combine service area assistance information, for example, with the WTRU's location information, e.g., to identify applicable service and/or valid areas. A service area may be considered applicable/valid, for example, based on satisfaction of one or more of the following conditions: the WTRU location is within the defined service area; the current time (e.g., UTC time) is within the service period (e.g., the current time is after the activation time but before the expiry time, or the current time is less than a duration after the activation time); and/or whether the WTRU satisfies an (e.g., any) access requirements (e.g., as described herein).

A network (NW) may indicate valid and/or applicable service areas. In some examples, a NW may indicate to a WTRU which service areas are applicable and/or valid for the WTRU. For example, a WTRU may transmit the WTRU's location information to the network. In response, the network may send a (e.g., dedicated) message (e.g., via RRC, DCI, NAS signaling, RA signaling, or MAC CE) informing the WTRU which service areas may be applicable and/or valid to receive data. The network may include (e.g., additional) assistance information, such as service area assistance information and/or one or more RNTIs to decode the data (e.g., as described herein).

A WTRU may report valid service areas. In some examples, a WTRU may report information related to which service areas are applicable and/or valid for the WTRU. The report may be triggered, for example, based on one or more of the following: a network request (e.g., an explicit network request); a detection of a change in valid and/or applicable service areas (e.g., a service area is no longer applicable, or a service area has become applicable, where the detection may be based on a location condition or a time-based trigger, such as expiration of a validity/service period); cell change (e.g., mobility or cell (re) selection); whether there was a change to the service area a WTRU may be (e.g., currently) receiving data from; random access; and/or an RRC state transition.

A WTRU may include, for example, one or more of the following pieces of information in a service area report: which service area(s) may be applicable and/or valid; which service area(s) may not be applicable and/or valid; which service area(s) the WTRU may be (e.g., currently) receiving information from; and/or which service areas the WTRU may need (e.g., require) verification of access requirements from (e.g., as described herein).

Whether a WTRU transmits a service area report may be based on, for example, a configuration from the network. A WTRU may transmit a report, for example, via one or more of the following: uplink control information (UCI), random access (RA) signaling, NAS signaling, RRC, and/or MAC CE.

Service area requirements may be configured. In some examples, a cell coverage area may partially move outside of a service area (e.g., due to cell movement). The network may continue to transmit information within the cell, but restrict access, which may prevent a WTRU outside of the service area, but within cell coverage, from accessing the service data.

Service restrictions and/or access requirements may be (de) activated. In some examples, conditions (e.g., requirements and/or restrictions) to access service data may be (de) activated (e.g., based on all or a portion of cell coverage moving into or out of the service area). For example, a cell with coverage fully within a service area may partially move out of the service area. The network may respond, for example, by activating one or more (e.g., some) restrictions for the reception of service data, e.g., to ensure that only those WTRU within the service area may receive data. In some examples, a cell with a portion of coverage outside of the service area may fully enter the service area, which may cause the network to deactivate one or more access requirements.

Service access requirements may include, for example, one or more of the following: a WTRU location must be known at the network (e.g., the WTRU must transmit or have previously transmitted the WTRU location information to the network); a WTRU location must be network verified (e.g., the WTRU location information, such as GNSS, has been verified by the network through a network verification procedure); a WTRU must remain inside the service area (e.g., the WTRU must notify the network upon detecting that it has left the service area); a WTRU location must be within a certain distance from the boundary of the service area. (e.g., the WTRU may be provided with a distance threshold and service area, where the requirement may not be fulfilled if the WTRU location falls below a distance threshold from the edge of the service area,); a WTRU must be in a specific RRC state (e.g., the WTRU must remain in RRC_CONNECTED); a WTRU must be registered to a specific tracking area or RAN notification area (RNA); and/or a WTRU must be served by a specific public land mobile network (PLMN).

One or more conditions (e.g., requirement(s)) to access a service area may depend on, for example, one or more of the following: the data sent within the service area, the reason to restrict the content (e.g., based on regulatory requirements or IP restrictions), and/or the region(s) surrounding the service area.

Service access requirements may be (de) activated. In some examples, service requirements may be (de) activated, e.g., per service area. For example, a service area (e.g., or MBS service/session ID) may be associated with a service access requirement. A WTRU (e.g., all WTRUs) accessing the service area may be subject to the service requirements. In some (e.g., alternative) examples, service requirements may be (de) activated per cell. For example, a service area may span (e.g., consist of) more than one cell. The network may indicate (e.g., per cell) whether access conditions (e.g., requirements) apply. A WTRU may (e.g., be required to) fulfill the condition(s) (e.g., requirement(s)) prior to accessing the service data, for example, depending on which cell the WTRU is connected to. Examples described herein may also apply, for example, per TAI, per beam, per reference area, per satellite, and/or per PLMN (e.g., if the service area includes multiple of those alternatives).

The (de) activation of service requirements may be (e.g., explicitly) indicated to the WTRU. In some examples, a WTRU may receive, via broadcast signaling, a (de) activation indication. In some examples, a WTRU may receive a (de) activation indication in a dedicated manner (e.g., via RA signaling, RRC, MAC CE, DCI, and/or NAS signaling). In some examples, a WTRU may (e.g., implicitly) determine that access conditions (e.g., requirements) are activated, for example, based on other information provided to the WTRU. For example, a WTRU may determine or assume that service requirements apply based on the validity period of the service area (e.g., upon determining that a portion of the cell has become invalid, as described herein).

A WTRU may determine or assume that service requirements (e.g., immediately) apply to a service area based on (e.g., upon) reception of a (de) activation indication. Service requirements may (e.g., alternatively) be associated with an “activation time” and/or “deactivation time.” An activation time may be a time (e.g., future time) when the service area will apply service requirements. A deactivation time may be a time (e.g., future time) when the service area will not apply service requirements.

More than one access requirement may apply to an access area. A (e.g., each) condition (e.g., requirement) may be associated with a (de) activation time. In some examples, a single (de) activation time may be provided for multiple (e.g., more than one) service conditions (e.g., requirements). A WTRU may determine or assume that a (de) activation time (provided for multiple service conditions) applies to all service conditions (e.g., requirements).

Service requirements may be verified. There may be conditions (e.g., requirements) to access data (e.g., currently, or at a future instance). A WTRU may transmit information to prove that the WTRU fulfills the conditions (e.g., requirements) and/or is eligible to receive (e.g., continue receiving) service data. The information may be (e.g., subsequently) verified by the network. The WTRU may transmit the information, for example, based on (e.g., upon) activation of service requirements, or at another (e.g., earlier) time (e.g., to ensure that reception of service data is not interrupted).

WTRU information may be reported to satisfy access conditions (e.g., requirements). A WTRU may transmit one or more pieces of information to access a service area (e.g., to satisfy or fulfill the access condition(s)/requirement(s)) via an access request or access requirement report. An access requirement report may be triggered, for example, by one or more of the following: a network request; activation of service requirements (e.g., at the activation time indication or determined via provided information); a time period before the activation of service requirements; accessing a cell with service area requirements; initiating a connection to a service with service area requirements; a WTRU without any remaining RNTIs to decode the service data; a WTRU with less than X number of remaining RNTIs to decode the service data.

A WTRU may transmit one or more pieces of information within an access request/report to verify the WTRU fulfills the access condition(s) (e.g., requirement(s)). For example, a WTRU may report one or more of the following: an MBS service/session ID; identifying information for the service area (e.g., an index); WTRU location information (e.g., GNSS information); one or more measurements related to radio quality (e.g., RSRP of serving and/or neighboring cells); one or more measurements related to position (e.g., positioning reference signal (PRS), round trip time (RTT), angle of arrival (AoA), angle of departure (AoD), etc.); one or more measurements and/or information to support network verification of WTRU location (e.g., RSRP of serving and/or neighboring cells, TA information, etc.); and/or an indication that one or more access requests may be pending (e.g., including identifying information).

A WTRU may include information (e.g., necessary information) to access a service area within a (e.g., single) report. A WTRU may be receiving data from multiple service areas. The WTRU may trigger (e.g., individual) reports for each service area (e.g., including only the data relevant for that service area) or the WTRU may include (e.g., all) information for multiple (e.g., all) service areas within a (e.g., single) report. The WTRU may transmit the report(s) via one or more of the following: UCI, RA signaling, NAS signaling, RRC, and/or MAC CE.

A network may receive WTRU access information. The network may (e.g., based on reception): 1) approve the information and allow the WTRU to continue receiving service data (e.g., via providing an RNTI, as described herein); 2) request additional information; or 3) reject the WTRU access request.

A WTRU may fail to fulfill the access condition(s) (e.g., requirement(s)). In some examples, a WTRU may fail to satisfy access requirements (e.g., prior to activation of the access requirements). Subsequent WTRU actions may depend upon the reason for access failure. For example, the WTRU may treat lack of network response differently from a rejection from the network.

In some examples, the WTRU may not receive a NW response to an access request and/or report prior to activation of access requirements. The WTRU may respond, for example, by performing one or more of the following: notify the network that the WTRU is still awaiting access to the service (e.g., via a flag in RA signaling, NAS signaling); retransmit the access request/access requirement report; and/or perform cell reselection or mobility to an alternative cell that may also be broadcasting the service data (e.g., as described herein).

In some examples, the network may respond to a (e.g., an initial) WTRU access request/report with a request for further information (e.g., additional measurements). The WTRU may send a subsequent access request/report including one or more of the requested pieces of information.

In some examples, the network may reject the WTRU (e.g., due to the NW verification failing). The WTRU may (e.g., relating to MBS data access or data access) be prevented from re-attempting to access the service area (e.g., permanently, or subject to a backoff time period), for example the WTRU may be barred from accessing cell(s), or the WTRU may perform one or more of the following actions: release information related to the access area (e.g., grants, configurations, assistance information, RNTIs, bearer, etc.); release to IDLE or INACTIVE; and/or bar the cell and/or set of cells belonging to the service area.

A WTRU may receive RNTI(s). In some examples, the method of MBS transmission may switch from broadcast to multicast signaling, e.g., based on the cell partially moving out of the service area. The network may provide an RNTI (e.g., a group RNTI (G-RNTI) or dedicated RNTI) to receive (e.g., or continue receiving) service data upon activation of service requirements. The network providing an RNTI may be based on/in response to receiving satisfactory WTRU access information (e.g., the network has verified that the WTRU location is within the access area).

A WTRU may (e.g., be required to) remain in one or more RRC states (e.g., a particular RRC state) to maintain the RNTI (e.g., the WTRU may be required to release the RNTI based on an RRC state). For example, the WTRU may maintain an RNTI in RRC_CONNECTED and RRC_INACTIVE state. The WTRU may or must release the RNTI based on (e.g., upon) reception of RRC_Release message (e.g., upon transition to RRC_IDLE). The WTRU may (e.g., be able to) retain the RNTI upon release to RRC_IDLE. The ability to maintain an RNTI may be (e.g., explicitly) indicated or configured (e.g., within an RRC_Release message).

A WTRU may receive one or more RNTIs via system information and/or via other signaling, such as RRC, DCI, MAC CE, and/or NAS signaling.

An RNTI may be subject to one or more RNTI validity criteria. A “valid” RNTI may be used to decode service data. A WTRU may consider an RNTI as “expired” or “not valid” within a cell, for example, if the RNTI can no longer be used to decode service data. Whether an RNTI is considered expired may be based on, for example, satisfaction of an expiry condition. A WTRU may consider an RNTI as not valid for reception/transmission of service data, for example, if one or more of the associated expiry conditions is satisfied.

For example, an RNTI may be associated with one or more of the following expiry conditions: reaching the end of cell coverage (e.g., upon t-Service); reaching a specific time (e.g., 10:23:34 UTC); reaching the end of the service area validity duration (e.g., as described herein); at the end of a time duration or offset; satisfaction of a condition; notification that the service area information has been updated (e.g., via a flag in system information, or a dedicated network message); (re) configuration; release from the network; cell change (e.g., upon mobility or cell reselection); change of network; and/or satellite change (e.g., from connection to an NGSO satellite to a GSO satellite).

A WTRU may consider an RNTI as not valid for reception/transmission of service data, for example, at the end of a time duration or offset. For example, the WTRU may consider an RNTI as valid from the beginning of a time duration, the WTRU will consider the RNTI as expired, for example, at the end of the time duration (e.g., or at a fixed offset from the time). The duration and/or the time offset may be provided to the WTRU, e.g., along with the RNTI, service area, and/or MBS service ID. The duration and/or the time offset may be maintained, for example, via a WTRU timer.

A WTRU may determine or consider an RNTI as not valid for reception/transmission of service data, for example, based on satisfaction of a condition. For example, a WTRU may set the WTRU location at the time of the RNTI validity period activation as the reference location, the WTRU can consider the validity criteria as expired, for example, if the WTRU has moved more than a configured threshold. The distance threshold may be provided/configured to the WTRU to perform the evaluation.

A WTRU may consider an RNTI as not valid for reception/transmission of service data, for example, based on (re) configuration. For example, the network may disable or deactivate an RNTI (e.g., or, alternatively, the service area or MBS service itself). The WTRU may consider the service area as expired, for example, based on reception of the reconfiguration.

A WTRU may consider an RNTI as not valid for reception/transmission of service data, for example, based on release from the network. For example, the WTRU may consider an RNTI as expired based on (e.g., upon) being released to RRC INACTIVE state (e.g., upon reception of an RRC_Release with suspend indication) or upon being release to RRC IDLE state (e.g., upon reception of an RRC_Release message).

A WTRU may consider an RNTI as not valid for reception/transmission of service data, for example, based on a change of network (e.g., transitioning from a cell originating from a terrestrial to non-terrestrial network). The WTRU may (e.g., alternatively) receive an RNTI (e.g., only) from a TN (e.g., satisfying the validity requirement), but may receive service data from an NTN cell.

Multiple RNTIs may be received to decode future data. A network may provide a WTRU with one or more RNTIs associated with a service area used to decode the service data, for example, if the network dynamically or periodically changes the RNTI used (e.g., required) to decode the service data (e.g., to prevent a WTRU from maintaining an RNTI longer than the expiry condition, or in case a WTRU improperly or mistakenly acquired an RNTI).

In some examples, a network may (e.g., periodically) update the RNTI for a (e.g., each) WTRU, or may (e.g., explicitly) indicate which RNTI to use (e.g., via an indication in system information or NAS signaling). In some examples, a (e.g., each) RNTI may be associated with a period of validity. The start of the validity period may be associated with an activation condition. For example, a service area may be associated with one or more of the following activation conditions: receiving the RNTI; starting cell coverage (e.g., upon t-ServiceStart); and/or reaching a specific time (e.g., 10:20:34 UTC).

A WTRU may use an RNTI (e.g., upon the start of the RNTI validity) to receive/decode service data from the service area associated with the RNTI until the RNTI expires. A WTRU may (e.g., based on RNTI expiry) select a different RNTI (e.g., valid RNTI) to continue decoding the service data.

In some examples, switching from one RNTI to another RNTI may not be fully orthogonal in time (e.g., there could be a time duration during which the service data may be transmitted in association with more than one RNTI). A WTRU may be configured with a time duration where the old and new RNTI may be associated with the service area, before switching to using only the new RNTI (e.g., WTRU decoding the PDSCH using both RNTIs, where higher layers may perform the duplicate detection and removal if the data was duplicated with both RNTIs).

RNTIs may be provided, for example, as a function of WTRU location (e.g., the number of RNTIs provided by the network may be a function of WTRU location). For example, a WTRU located in a cell center far away from the MBS session area edge may have several RNTIs, whereas a WTRU located near the edge may receive (e.g., only) one RNTI. Providing RNTIs may (e.g., additionally and/or alternatively) be a function of satellite speed, how much of the area is within the non-confirming zone (e.g., a zone where the WTRU is barred from access as described herein), etc.

A WTRU may perform one or more actions upon RNTI expiry. A WTRU that runs out of RNTIs may repeat one or more aspects of an access request/verification procedure (e.g., as described herein) to receive additional RNTIs. A WTRU may re-initiate a procedure, for example, based on one or more of the following: the WTRU has no remaining RNTIs to decode the service data; the WTRU has less than X number of remaining RNTI(s) to decode the service data; and/or the WTRU has X validity time left for one or more RNTIs. The number ‘X’ may be (pre-) configured. The validity time may be (pre-) configured.

There may be service continuity in moving cells. In some examples, a cell may no longer be considered a valid cell to transmit/receive the service data associated with a service area if the cell coverage area (e.g., some or all) moves outside of the service area. The network may stop transmitting the information (e.g., MBS data) within the cell. A WTRU may re-connect (e.g., perform cell reselection or mobility) to an alternative cell to continue receiving service data.

Neighbor cell assistance information may be provided regarding MBS session areas. A WTRU may be provided with neighbor cell assistance information, for example, to support service continuity for a session area. The assistance information may include one or more of the following pieces of information: a description of the service area within the neighboring cell (e.g., including one or more pieces of information described herein); a description of the service area validity duration for the neighboring cell (e.g., including one or more pieces of information described herein); a description of the service area requirements to access the service area in the neighboring cell (e.g., including one or more pieces of information described herein); information to access the neighboring cell (e.g., satellite assistance information, NTN-config, epoch time, neighbor cell satellite ephemeris, etc.); and/or whether the current RNTIs are valid in the neighboring cell.

A WTRU may receive assistance information from one or more neighboring cells, for example, via system information and/or other signaling, such as RRC, DCI, MAC CE, and/or NAS signaling. Neighbor cell assistance information may be provided autonomously by the network (e.g., based on imminent expiry of a service area validity for the cell), or may be (e.g., explicitly) requested by the WTRU.

A WTRU may be transitioned to neighbor cell for service continuity of a service area. A WTRU may (e.g., at or prior to expiry of the service period for the current serving/camped cell) identify one or more valid neighboring cells that may also be broadcasting service data associated with an MBS service area (e.g., via use of the neighbor cell assistance information). The WTRU may perform one or more of the following actions (e.g., to transition to the neighboring cell): transmit an indication that an alternative cell is valid for the WTRU to continue the service; trigger a measurement report (e.g., the WTRU may (only) include measurements associated with neighbor cells that are also transmitting the service data); perform cell reselection (e.g., to a neighbor cell that is transmitting the service data); perform random access (e.g., to a neighbor cell that is transmitting the service data); and/or activate a conditional reconfiguration (e.g., conditional handover).

A WTRU may transmit an access request to a neighbor cell (e.g., including information to verify the WTRU may access the cell), for example, if the neighboring cell has access restrictions to receive data from the service area. Whether the WTRU sends the access request may depend on an (e.g., explicit) request/indication from the network and/or on the WTRU action performed to transition to the neighbor cell. For example, a serving cell may have already forwarded a relevant information for a WTRU performing mobility to a neighbor cell, indicating an access request may not be needed. An access request may (e.g., also) not be needed if the RNTIs received in the serving cell are valid in the neighbor cell (the RNTI(s) may have been indicated as valid for a neighboring cell as part of providing the RNTI(s) to the WTRU). A WTRU may send an access request, for example, if the serving cell didn't have access requirements but the target cell does have access requirements.

There may be more than one suitable neighboring cell available. A WTRU may rank multiple neighboring cells, for example, to select the most suitable cell to continue receiving the service. The WTRU may rank the neighboring cells, for example, based on one or more of the following criteria: cell measurements (e.g., RSRP); remaining service period associated with the MBS service area (e.g., the remaining validity duration); remaining time of cell service (e.g., the remaining time until t-Service); and/or whether the cell has access requirements.

There may not be neighboring cells available to continue a session. A WTRU without neighboring cells to continue a session may, for example, send an indication to the network, trigger random access, or continue receiving service data on the current cell until expiry.

A WTRU may transition to neighbor cell to continue a session for RRC_CONNECTED. A WTRU may be configured with a Cond T1/D1/D2 configuration for performing conditional HOs from one satellite cell to another satellite cell. In some examples, a conditional configuration possibility may be leveraged to perform mobility decisions that may be dependent on active multicast/broadcast sessions the WTRU is participating in. For example, a WTRU may be configured with a (e.g., one) Cond T1 triggering condition/threshold associated with performing a CHO when the WTRU does not have an active multicast/broadcast session. The WTRU may be configured with another Cond T1 triggering condition/threshold associated with performing CHO when the WTRU has an active multicast/broadcast session. The serving cell of WTRU(s) that are not participating in the multicast/broadcast service may not be impacted when/if the satellite cells (e.g., partially) enter a geographical area where the multicast/broadcast session may not be transmitted/received.

A WTRU may receive a time-dependent RNTI for service data reception. In some examples, a WTRU may receive MBS content data as a function of whether the MBS session area remains valid within the serving cell and/or whether the WTRU location has satisfied MBS service area access restrictions (e.g., the WTRU location has been network verified). The WTRU may receive a series of RNTIs to decode MBS session data each with an associated validity period. The number of RNTIs provided to a WTRU may be a function of, for example, cell movement, WTRU location, and/or MBS session area.

MBS content data may be received as a function of whether a WTRU location has fulfilled access conditions (e.g., requirements) and/or the validity of a service area. A WTRU may receive a series of RNTIs to decode MBS session data, e.g., each with an associated validity period. The number of RNTIs provided to a WTRU may be a function of cell movement, WTRU location, and/or MBS session area.

One or more of the following may be performed. A WTRU may receive (e.g., via system information) a list of session identifiers (IDs) (e.g., MBS session IDs). The WTRU may obtain (e.g., determine) location information for the WTRU (e.g., the location information may be information indicative of the location of the WTRU), and, the WTRU may identify (e.g., determine) one or more valid service areas (e.g., MBS service areas), for example, based on the location information. For example, the WTRU may determine that an service area associated with the WTRU is a valid MBS service area. The WTRU may transmit information to the network associated with satisfying access requirement(s) (e.g., the WTRU may, based on the determination that the service area associated with the WTRU is a valid service area, send an access request to a network node, such as a base station), where, for example, the access requirement(s) may be requirement(s) to access data (e.g., receive and/or decode data (e.g., MBS data). The WTRU may receive one or more RNTIs associated with decoding data (e.g., a type of data, such as MBS-type data). For example, the WTRU may receive a message that indicates a first RNTI, an indication of a first period of validity associated with the first RNTI, a second RNTI, and a second period of validity associated with the second RNTI, etc. The WTRU may determine that one or more of the RNTIs are valid (e.g., valid to use for decoding the data) based on being within one or more of the periods of validity (e.g., the WTRU may determine that a first time is within the first period of validity, and, decode MBS data via use of the first RNTI based on the determination that the first time is within the first period of validity). The WTRU may determine that the first period of validity expired or is within a threshold of expiration. The WTRU may determine that a second time is within the second period of validity, where the second time is at or after expiration of the first period of validity. The WTRU may decode the data via use of the second RNTI based on the determination that the second time is within the second period of validity. MBS session ID, MBS service area, MBS data, and the like, may be used herein as examples of session ID, service area, data, and the like without loss of generality.

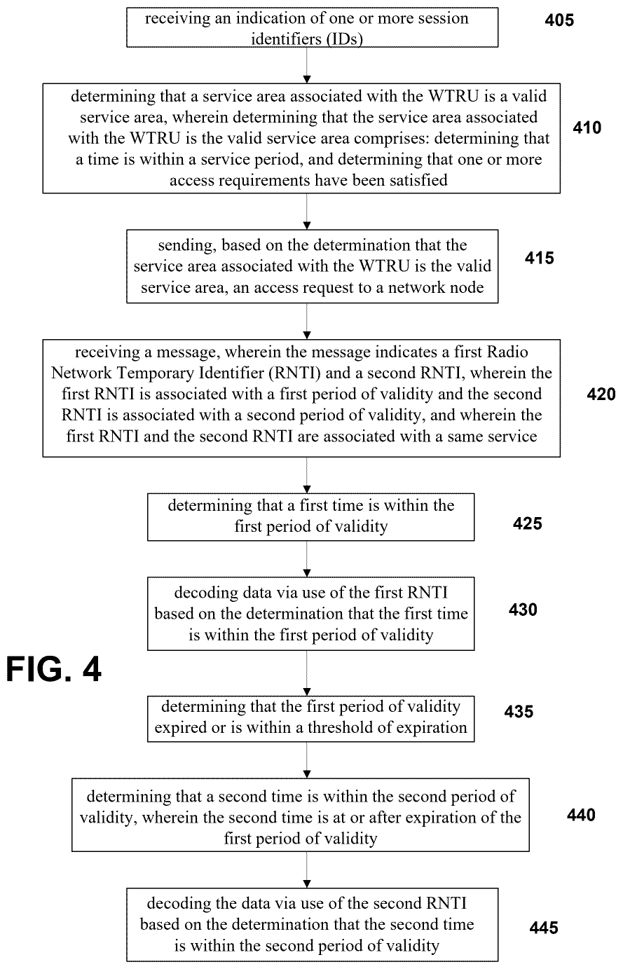

FIG. 4 illustrates an example associated with decoding data (e.g., MBS data), where one or more of the illustrated actions may be performed. A WTRU may perform one or more of the following actions (405-445): receiving an indication of one or more session identifiers (IDs); determining that a service area associated with the WTRU is a valid service area, wherein determining that the service area associated with the WTRU is the valid service area comprises: determining that a time is within a service period, and determining that one or more access requirements have been satisfied; sending, based on the determination that the service area associated with the WTRU is the valid service area, an access request to a network node; receiving a message, wherein the message indicates a first Radio Network Temporary Identifier (RNTI) and a second RNTI, wherein the first RNTI is associated with a first period of validity and the second RNTI is associated with a second period of validity, and wherein the first RNTI and the second RNTI are associated with a same service; determining that a first time is within the first period of validity; decoding data via use of the first RNTI based on the determination that the first time is within the first period of validity; determining that the first period of validity expired or is within a threshold of expiration; determining that a second time is within the second period of validity, wherein the second time is at or after expiration of the first period of validity; or decoding the data via use of the second RNTI based on the determination that the second time is within the second period of validity.

The one or more access requirements may comprise a requirement that the WTRU verify that the WTRU is in a location associated with allowing access to the data. The one or more session IDs may comprise a first session ID and a second session ID. The first session ID may indicate one or more of: a first service area, a first service period associated with the first session ID, or a first access condition associated with the first session ID. The second session ID may indicate one or more of: a second service area, a second service period associated with the second session ID, or a second access condition associated with the second session ID. The first or second access condition may comprise a condition that a time associated with access by the WTRU is a time when the WTRU is allowed to at least one of: access the data or decode the data. The service area associated with the WTRU may be the first service area or the second service area. Determining that the service area associated with the WTRU is the valid service area may comprise: determining one or more of: that the time is within the first service period, that a location associated with the WTRU is within the first service area, or that the first access condition is satisfied; or, determining one or more of: that the time is within the second service period, that a location associated with the WTRU is within the second service area, or that the second access condition is satisfied

The access request may indicate one or more of: a session ID, wherein the session ID is one of the one or more session IDs, WTRU location information, or measurement information associated with measurements performed by the WTRU. The one or more session IDs may be one or more multicast broadcast service (MBS) IDs, the service area may be an MBS service area, the service period may be an MBS service period, and/or the data is MBS data. The data may be MBS-type data. The one or more session IDs may be one or more service area IDs. Being associated with the same service may comprise being associated with a same session.

A network entity (e.g., a network node, such as a base station) may receive the access request from the WTRU. The network entity may verify information in the access request. For example, the network entity may determine that the WTRU is allowed to access the data. The network entity determining that the WTRU is allowed to access the data may comprise the network entity determining that measurements indicated in the access request indicate that the location of the WTRU is a location where the WTRU is allowed to access the data (e.g., the location is not a location that would indicate the WTRU is prohibited from accessing the data). The network entity may send a plurality of RNTIs to the WTRU (e.g., comprising the first and second RNTIs). For example, the network entity may send the plurality of RNTIs based on the determination by the network entity that the WTRU is allowed to access the data. By sending multiple RNTIs to the WTRU, the network entity may control how long the WTRU can access data based on how close the network entity determines that the WTRU will be to a border (e.g., a border where access is no longer permissiblel).

A WTRU may receive (e.g., via system information) a list of MBS session IDs (e.g., session identifiers). An MBS session ID (e.g., session ID) may include one or more of the following: an indication and/or description of one or more MBS service area(s) (e.g., per cell/beam, a reference point and radius, polygonal description, link to TN area, country/city code, tracking area defined as a group of cells, etc.); a service period associated with the MBS service area (e.g., a start time, an end time, a duration, etc.), for example a respective service period associated with a respective service area; condition(s) (e.g., requirements) to access the MBS content data (e.g., content data, data, etc.) (e.g., where the condition(s) may include an indication of whether NW verification of WTRU location is required); and/or an indication if and/or when access conditions (e.g., requirements) may be applied (e.g., currently, at some time in the future, etc.).

The WTRU may obtain/determine the WTRU's location information. The WTRU may identify one or more valid MBS service areas (e.g., based on the WTRU's location information). An MBS service area may be considered valid, for example, based on satisfaction of one or more of the following conditions: the WTRU location is within a defined MBS service area; a time, such as a current time, e.g., UTC time, is within the MBS service period; or the WTRU satisfies the condition(s) (e.g., requirement(s) to access the data (e.g., the WTRU location information has been verified, for example verified by the WTRU).

The WTRU may (e.g., if there are condition(s)/requirement(s) to access the data, such as at a current time or at a future time) transmit information (e.g., an access request) to fulfill a condition(s)/requirement(s). The WTRU may transmit the information to fulfill the condition(s)/requirement(s) prior to the condition(s)/requirement(s) being applied. The transmitted information may include, for example, one or more of the following: an MBS session ID; the WTRU's location information (e.g., GNSS information); or measurements and/or information that may be used by a network to verify the WTRU's location (e.g., RSRP of current and neighboring cells, TA information, etc.).

The WTRU may receive one or more RNTIs. The one or more RNTIs may be used to decode the MBS data (e.g., upon satisfaction of the access requirements). An RNTI (e.g., each RNTI) may be associated with a period of validity (e.g., activation time and/or validity duration). For example, a received first RNTI may be associated with a first period of validity and a received second RNTI may be associated with a second period of validity.

The WTRU may apply and/or use a RNTI of the one or more RNTIs, for example, a RNTI associated with the current time period (e.g., a RNTI for which a first usage time satisfies a corresponding period of validity), to decode the MBS data. The WTRU may (e.g., if the period of validity associated with the current RNTI expires) select a different RNTI, for example, a RNTI for which a second usage time satisfies a corresponding period of validity, (e.g., a valid RNTI) to decode (e.g., continue decoding) the MBS data (e.g., MBS-type data).

The WTRU may perform (e.g., repeat) one or more of the operations/actions described herein to obtain additional RNTI(s) (e.g., to continue decoding MBS-type data), for example, if there are no remaining valid RNTIs. For example, the WTRU may send one or more of the following: an MBS session ID (e.g., another MBS session ID); the WTRU's location information (e.g., location information associated with when the WTRU is performing the repeated operation(s)/action(s)); or measurements and/or information that may be used by a network to verify WTRU location (e.g., associated with when the WTRU is performing the repeated operation(s)/action(s)). MBS service continuity may be provided for moving cells. In some examples, a NW may decide to suspend or stop (e.g., entirely) providing data associated with a service area or MBS session (e.g., due to satellite movement causing the cell to no longer serve the service area). A WTRU may be provided additional assistance information for neighboring cells (e.g., indicating which neighbor cells are transmitting the service data, neighbor cell ephemeris, etc.) to support service continuity of the MBS service. A WTRU may (e.g., at the time or a time period before the serving cell stops transmitting the service data) perform mobility or cell reselection, prioritizing a neighboring cell which supports the service area.

For example, a WTRU may perform one or more of the following to support MBS service continuity (e.g., in Earth moving cells): receive (e.g., via system information) a list of MBS session IDs; obtain the WTRU's location information and/or identify one or more valid MBS service areas; receive MBS data from one or more valid MBS service areas; perform one or more operations if the MBS service period is about to expire.

A WTRU may receive (e.g., via system information) a list of MBS session IDs. A session ID may include, for example, one or more of the following: a description of one or more MBS service areas (e.g., per cell/beam, a reference point and radius, polygonal description, link to TN area, etc.); a service period associated with the MBS service area (e.g., a start time, an end time, a duration, etc.); and/or a list of neighboring cell(s) that may also be broadcasting the same MBS session data, and their service period.

A WTRU may obtain the WTRU's location information and/or identify one or more valid MBS service areas. An MBS service area may be considered valid based on satisfaction of one or more of the following conditions: the WTRU location is within the defined MBS service area; and/or the current time (e.g., UTC time) is within the MBS service period. The WTRU may receive MBS data from one or more valid MBS service areas.

A WTRU may perform one or more operations, for example, if the MBS service period is about to expire (e.g., based on one or more expiry conditions such as the end time of the service period). For example, the WTRU may identify one or more valid neighboring cells that may also be broadcasting MBS data associated with the MBS service area. The WTRU may (e.g., at or prior to expiry of the MBS service period for the current serving/camped cell) perform mobility/cell reselection to a valid neighboring cell that also broadcasts the MBS data associated with the service area. The WTRU may rank neighboring cells (e.g., if more than one suitable neighboring cell is available), for example, based on one or more of the following criteria: cell measurements (e.g., RSRP, remaining MBS service period associated with the MBS service area, remaining time of cell service, etc.). The WTRU may send an indication to the network, for example, if there are no neighboring cells available.

In some examples, in MBS continuity for moving cells a WTRU may continue to receive service data from a neighboring cell if the current service cell stops providing the service data (e.g., due to satellite movement).

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

We claim:

1. A wireless transmit/receive unit (WTRU), comprising:
a processor, wherein the processor is configured to:
receive an indication of one or more session identifiers (IDs);
determine that a service area associated with the WTRU is a valid service area, wherein being configured to determine that the service area associated with the WTRU is the valid service area comprises the processor being configured to at least: determine that a time is within a service period, and determine that one or more access requirements have been satisfied;
send, based on the determination that the service area associated with the WTRU is the valid service area, an access request to a network node;
receive a message, wherein the message indicates a first Radio Network Temporary Identifier (RNTI) and a second RNTI, wherein the first RNTI is associated with a first period of validity and the second RNTI is associated with a second period of validity, and wherein the first RNTI and the second RNTI are associated with a same service;
determine that a first time is within the first period of validity;
decode data via use of the first RNTI based on the determination that the first time is within the first period of validity;
determine that the first period of validity expired or is within a threshold of expiration;
determine that a second time is within the second period of validity, wherein the second time is at or after expiration of the first period of validity; and
decode the data via use of the second RNTI based on the determination that the second time is within the second period of validity.

2. The WTRU of claim 1, wherein the one or more access requirements comprise:
a requirement that the WTRU verify that the WTRU is in a location associated with allowing access to the data; or
a requirement that the network node verify a WTRU location.

3. The WTRU of claim 1, wherein the one or more session IDs comprise a first session ID and a second session ID, and wherein:
the first session ID indicates one or more of: a first service area, a first service period associated with the first session ID, or a first access condition associated with the first session ID, and
the second session ID indicates one or more of: a second service area, a second service period associated with the second session ID, or a second access condition associated with the second session ID.

4. The WTRU of claim 3, wherein the first or second access condition comprises:
a condition that a time associated with access by the WTRU is a time when the WTRU is allowed to at least one of: access the data or decode the data; or
a condition that the network node verify a WTRU location.

5. The WTRU of claim 3, wherein the service area associated with the WTRU is the first service area or the second service area, and wherein being configured to determine that the service area associated with the WTRU is the valid service area comprises the processor being configured to:
determine one or more of: that the time is within the first service period, that a location associated with the WTRU is within the first service area, or that the first access condition is satisfied, or
determine one or more of: that the time is within the second service period, that a location associated with the WTRU is within the second service area, or that the second access condition is satisfied.

6. The WTRU of claim 1, wherein the access request indicates one or more of:
a session ID, wherein the session ID is one of the one or more session IDs, WTRU location information, or
measurement information associated with measurements performed by the WTRU.

7. The WTRU of claim 1, wherein the one or more session IDs are one or more multicast broadcast service (MBS) IDs, wherein the service area is an MBS service area, wherein the service period is an MBS service period, and wherein the data is MBS data.

8. The WTRU of claim 1, wherein the data is MBS-type data.

9. The WTRU of claim 1, wherein the one or more session IDs are one or more service area IDs.

10. The WTRU of claim 1, wherein being associated with the same service comprises being associated with a same session.

11. A method implemented in a wireless transmit/receive unit (WTRU), the method comprising:
receiving an indication of one or more session identifiers (IDs);
determining that a service area associated with the WTRU is a valid service area, wherein determining that the service area associated with the WTRU is the valid service area comprises: determining that a time is within a service period, and determining that one or more access requirements have been satisfied;
sending, based on the determination that the service area associated with the WTRU is the valid service area, an access request to a network node;
receiving a message, wherein the message indicates a first Radio Network Temporary Identifier (RNTI) and a second RNTI, wherein the first RNTI is associated with a first period of validity and the second RNTI is associated with a second period of validity, and wherein the first RNTI and the second RNTI are associated with a same service;
determining that a first time is within the first period of validity;
decoding data via use of the first RNTI based on the determination that the first time is within the first period of validity;
determining that the first period of validity expired or is within a threshold of expiration;
determining that a second time is within the second period of validity, wherein the second time is at or after expiration of the first period of validity; and
decoding the data via use of the second RNTI based on the determination that the second time is within the second period of validity.

12. The method of claim 11, wherein the one or more access requirements comprise:
a requirement that the WTRU verify that the WTRU is in a location associated with allowing access to the data; or
a requirement that the network node verify a WTRU location.

13. The method of claim 11, wherein the one or more session IDs comprise a first session ID and a second session ID, and wherein:
the first session ID indicates one or more of: a first service area, a first service period associated with the first session ID, or a first access condition associated with the first session ID, and
the second session ID indicates one or more of: a second service area, a second service period associated with the second session ID, or a second access condition associated with the second session ID.

14. The method of claim 13, wherein the first or second access condition comprises:
a condition that a time associated with access by the WTRU is a time when the WTRU is allowed to at least one of: access the data or decode the data; or
a condition that the network node verify a WTRU location.

15. The method of claim 13, wherein the service area associated with the WTRU is the first service area or the second service area, and wherein determining that the service area associated with the WTRU is the valid service area comprises:
determining one or more of: that the time is within the first service period, that a location associated with the WTRU is within the first service area, or that the first access condition is satisfied, or
determining one or more of: that the time is within the second service period, that a location associated with the WTRU is within the second service area, or that the second access condition is satisfied.

16. The method of claim 11, wherein the access request indicates one or more of:
a session ID, wherein the session ID is one of the one or more session IDs, WTRU location information, or
measurement information associated with measurements performed by the WTRU.

17. The method of claim 11, wherein the one or more session IDs are one or more multicast broadcast service (MBS) IDs, wherein the service area is an MBS service area, wherein the service period is an MBS service period, and wherein the data is MBS data.

18. The method of claim 11, wherein the data is MBS-type data.

19. The method of claim 11, wherein the one or more session IDs are one or more service area IDs.

20. The method of claim 11, wherein being associated with the same service comprises being associated with a same session.
